(19) United States
(12) Patent Application Publication
(10) Pub. No.: US 2026/0294187 A1
(43) Pub. Date: Oct. 1, 2026

(54) Dust Collection Station for Vacuum Cleaner and Cleaning System Thereof

(71) Applicant: SHENZHEN CHENBEI TECHNOLOGY CO., LTD., SHENZHEN (CN)

(72) Inventors: Junping Li, SHENZHEN (CN); Peng Sun, SHENZHEN (CN); Guorui Zhang, SHENZHEN (CN)

(73) Assignee: SHENZHEN CHENBEI TECHNOLOGY CO., LTD., SHENZHEN, GD (CN)

(21) Appl. No.: 18/880,235

(22) PCT Filed: Sep. 18, 2024
(86) PCT No.: PCT/CN2024/119352

§ 371 Date: Dec. 30, 2024

(30) Foreign Application Priority Data
Sep. 20, 2023 (CN) 202322568088.4

(51) Int. Cl. A47L 9/14; A47L 9/00; F16H 19/04

(52) U.S. Cl. CPC A47L 9/149; A47L 9/0063; F16H 19/04

(57) ABSTRACT

A vacuum cleaner dust collecting station includes a main body, a dust cup assembly, and a drive assembly. A dust collecting chamber is provided inside the main body, and an opening is defined at the top of the main body. The dust cup assembly can be placed in or taken out of the dust collecting chamber through the opening. The dust cup assembly includes a cup body and a bottom cover, and the bottom of the cup body is provided with a dust outlet, the bottom cover is rotatably connected to the edge of the dust outlet, and can rotate around the edge of the dust outlet to close or open the dust outlet. The drive assembly is installed in the dust collecting chamber, and is configured to drive the bottom cover to rotate and further close the dust outlet as the dust cup assembly moves upward.

### CROSS-REFERENCE TO RELATED APPLICATIONS

This present application claims the benefit of the priority filing date of PCT application number PCT/CN2024/119352, filed on Sep. 18, 2024, which claims the benefit of the priority filing date of Chinese Patent Application No. 202322568088.4, entitled “Dust Collection Station for Vacuum Cleaner and Cleaning System Thereof” and filed on Sep. 20, 2023, which is hereby incorporated herein by reference in its entirety.

### FIELD OF THE INVENTION

The present application relates to the field of cleaning equipment, in particular to a dust collecting station for a vacuum cleaner and a cleaning system of the dust collecting station for the vacuum cleaner.

### BACKGROUND

A vacuum cleaner usually includes a dust cup assembly installed on the vacuum cleaner and a dust collection station for the vacuum cleaner. When the vacuum cleaner is not in use, the vacuum cleaner is placed in the dust collection station for the vacuum cleaner, and the dust cup assembly can open the bottom cover to collect dust. When the dust collection is completed and the user needs to use the vacuum cleaner, the vacuum cleaner needs to be taken out of the dust collection station for the vacuum cleaner. The bottom cover of the dust cup assembly does not close automatically, and it needs the user to manually close the bottom cover of the dust cup, which is frequent and labor-intensive, and is apt to dirty the user's hands and the vacuum cleaner, which cannot keep the vacuum cleaner and the user's hands clean.

### SUMMARY

Based on this, a dust collecting station for a vacuum cleaner is provided by the application for the above technical problems.

The dust collecting station for the vacuum cleaner includes a main body, a dust cup assembly, and a driving assembly. An interior of the main body is provided with a dust collecting chamber, an opening is defined at the top of the main body, and the opening in communication with the dust collecting chamber. The dust cup assembly is able to be accommodated in the dust collecting chamber through the opening or taken out of the dust collecting chamber through the opening. The dust cup assembly includes a cup body and a bottom cover, the bottom of the cup body is provided with a dust outlet, the bottom cover is located at the dust outlet and is rotatably connected to the cup body for closing or opening the dust outlet. The driving assembly is installed in the dust collecting chamber, and is configured to drive the bottom cover to rotate and close the dust outlet as the dust cup assembly is taken out of the dust collecting chamber.

In this way, the dust collecting chamber inside the main body is used to contain dust, and the opening of the dust collecting chamber can be used to put the vacuum cleaner in or take the vacuum cleaner out. When the vacuum cleaner is used and then placed inside the main body, the dust cup assembly is also placed in the dust collecting chamber. At this time, the bottom cover of the dust cup assembly is opened, and the dust accumulated in the dust cup assembly may be poured into the dust collecting chamber through the dust outlet to achieve dust cleaning. The drive assembly is configured to respond to the movement of the dust cup assembly. When the dust cup assembly is taken out of the dust collecting chamber in an upward direction, the drive assembly can respond to the action, drive the bottom cover to rotate and close the dust outlet, so that the user does not need to frequently operate to close the dust outlet, and when the dust cup assembly is taken out of the dust collecting chamber, the dust outlet is already closed, so dust may not overflow outside the dust collecting chamber. In one embodiment, the dust cup assembly also includes a lock member, which is connected to the cup body to present the bottom cover that covers the dust outlet from rotating.

In one embodiment, the lock member is connected to the cup body, and the lock member is provided with a slot, and a protrusion is provided on the outer peripheral wall of the bottom cover, and the protrusion extends outwards radially.

In one embodiment, a mounting groove is defined on the side wall of the cup body, and one notch of the mounting groove on one side is defined on the outer peripheral wall of the cup body, and the other notch of the mounting groove on the other side is defined on the inner peripheral wall of the cup body, and the lock member is installed in the mounting groove and can rotate in the mounting groove, and the lock member is provided with the slot at one end close to the dust outlet, and the other end of the lock member extends toward the notch of the mounting groove provided on the outer peripheral wall of the cup body.

In one embodiment, the driving assembly includes a toggle rod. One end of the toggle rod is rotatably connected to the inner wall of the main body, and the other end of the toggle rod extends away from the inner wall of the main body. The toggle rod can rotate around the end connected to the main body. When the dust cup assembly leaves the dust collection chamber, the end of the toggle rod away from the inner wall of the main body abuts against the center position of the bottom cover and pushes the bottom cover to rotate for closing the dust outlet.

In one embodiment, a matching block is provided on the toggle rod, which is connected to the toggle rod and extends away from the toggle rod. The edge of the dust outlet is provided with a matching flange, which extends radially outwards; when the cup body is placed in the dust collection chamber, the matching block overlaps the side of the matching flange facing the opening.

In one embodiment, the toggle rod is arc-shaped and bent toward the axis of the main body.

In one embodiment, the driving assembly includes a rack, which is arranged on the inner wall of the main body and arranged in the axis direction of the main body; a gear is connected to the side of the bottom cover facing the rack, and the gear can rotate in the direction of movement of the dust cup assembly and drive the bottom cover to rotate synchronously; as the dust cup assembly enters the dust collecting chamber or is taken out of the dust collecting chamber, the gear can mesh with the rack and rotate.

In one embodiment, as the dust cup assembly enters the dust collecting chamber or is taken out of the dust collecting chamber, the gear can rotate at least a quarter of a rotation.

The application also provides a cleaning system, including the dust collecting station of the vacuum cleaner as described above.

Compared with the prior art, the application accommodates dust through the dust collecting chamber inside the main body, and the opening of the dust collecting chamber can be used for placing and taking out the vacuum cleaner. When the vacuum cleaner is used and then placed inside the main body, the dust cup assembly is also accommodated in the dust collecting chamber. At this time, the bottom cover of the dust cup assembly is opened, and the dust accumulated in the dust cup assembly can be poured into the dust collecting chamber through the dust outlet to achieve dust cleaning. The driving assembly is configured to respond to the movement of the dust cup assembly. When the dust cup assembly is taken out of the dust collection chamber in an upward direction, the driving assembly can respond to the action, drive the bottom cover to rotate and close the dust outlet, so that the user does not need to frequently operate to close the dust outlet. Moreover, when the dust cup assembly is taken out of the dust collection chamber, the dust outlet is already closed, so dust may not overflow outside the dust collection chamber.

### BRIEF DESCRIPTION OF THE DRAWINGS

FIG. 1 is a partial cut-away elevation view of a first embodiment of a vacuum cleaner dust collecting station as disclosed herein;

FIG. 2 is a partial cut-away elevation view of a dust cup assembly of the first embodiment of the vacuum cleaner dust collecting station as disclosed herein, without being placed in the vacuum cleaner dust collecting station;

FIG. 3 is a partial cut-away elevation view of a second embodiment of a vacuum cleaner dust collecting station as disclosed herein;

FIG. 4 is a cut-away elevation view of the dust cup assembly as disclosed herein;

FIG. 5 is a cut-away elevation view of the vacuum cleaner dust collecting station.

The reference numbers in the figures represent the following: 100, vacuum cleaner dust collecting station; 10, main body; 11, dust collecting chamber; 12, opening; 20, drive assembly; 21, toggle rod; 211, matching block; 22, rack; 23, gear; 30, dust cup assembly; 31, cup body; 311, mounting groove; 312, dust outlet; 32, bottom cover; 321, protrusion; 322, matching flange; 33, lock member; 331, slot.

### DETAILED DESCRIPTION OF THE EMBODIMENTS

In order to make the above-mentioned purposes, features and advantages of the present application more apparent and easy to understand, the specific implementation methods of the present application are described in detail below in conjunction with the accompanying drawings. In the following description, many specific details are set forth to facilitate a full understanding of the present application. However, the present application can be implemented in many other ways different from those described herein, and those skilled in the art can make similar improvements without violating the connotation of the present application, so the present application is not limited to the specific embodiments disclosed below.

It should be noted that when a mechanism is referred to as “fixed to” or “set on” another mechanism, it can be directly on the other mechanism or there can also be a central mechanism. When a mechanism is considered to be “connected” to another mechanism, it can be directly connected to the other mechanism or there may be a central mechanism at the same time. The terms “vertical”, “horizontal”, “upper”, “lower”, “left”, “right” and similar expressions used in the specification of the present application are only for the purpose of illustration and do not represent the only implementation method.

In addition, the terms “first” and “second” are used only for descriptive purposes and cannot be understood as indicating or implying relative importance or implicitly indicating the number of technical features indicated. Therefore, the features defined as “first” and “second” can explicitly or implicitly include at least one of the features. In the description of this application, “multiple” means at least two, such as two, three, etc., unless otherwise clearly specified and specifically defined.

In this application, unless otherwise clearly specified and defined, the first feature “above” or “below” the second feature may be that the first feature is directly in contact with the second feature, or the first feature and the second feature are indirectly in contact through an intermediate medium. Moreover, the first feature “above”, “above” and “above” the second feature may be that the first feature is directly above or obliquely above the second feature, or simply indicates that the first feature is higher in level than the second feature. The first feature “below”, “below” and “below” the second feature may be that the first feature is directly below or obliquely below the second feature, or simply indicates that the first feature is lower in level than the second feature.

Unless otherwise defined, all technical and scientific terms used in the specification of this application have the same meaning as those generally understood by technicians in the technical field of this application. The terms used in the specification of this application are only for the purpose of describing specific embodiments and are not intended to limit this application. The term “and/or” used in the specification of this application includes any and all combinations of one or more related listed items.

A conventional vacuum cleaner usually includes a dust cup assembly installed on the vacuum cleaner and a vacuum cleaner dust collection station. When the vacuum cleaner is not in use, the vacuum cleaner is placed in the vacuum cleaner dust collection station, and the dust cup assembly can open the bottom cover to collect dust. When the user needs to use the vacuum cleaner after dust collection, the vacuum cleaner needs to be taken out of the vacuum cleaner dust collection station. The bottom cover of the dust cup assembly cannot close automatically, and it needs the user to close the bottom cover of the dust cup manually or with other electric mechanisms. This operation is frequent and labor-intensive, and the user's hands and the vacuum cleaner are easily dirty, and the vacuum cleaner and the user's hands cannot be kept clean. In view of this technical problem, the application provides a vacuum cleaner dust collection station 100, which can make the bottom cover 32 of the dust cup assembly 30 automatically close, reduce the user's operating steps, and avoid dust spillage.

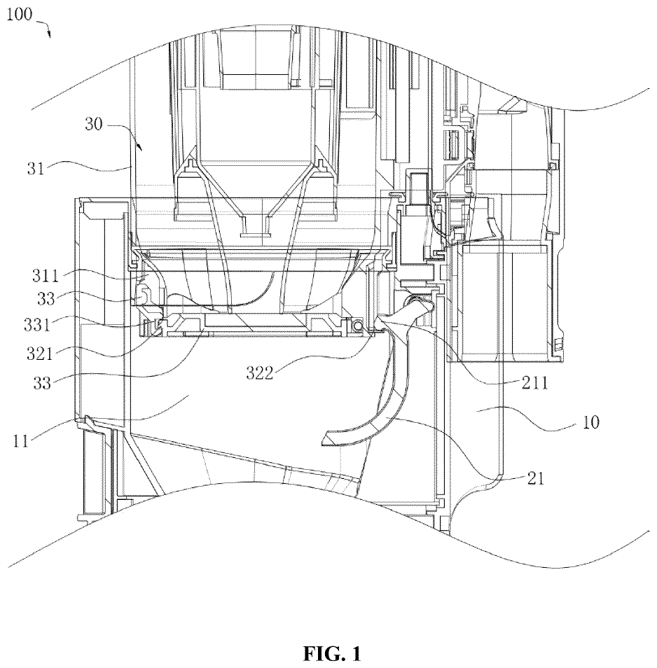

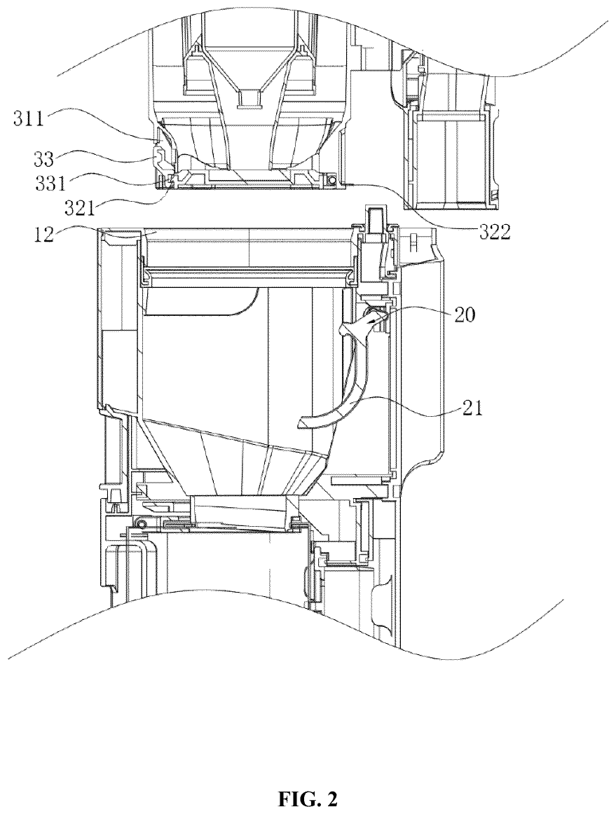

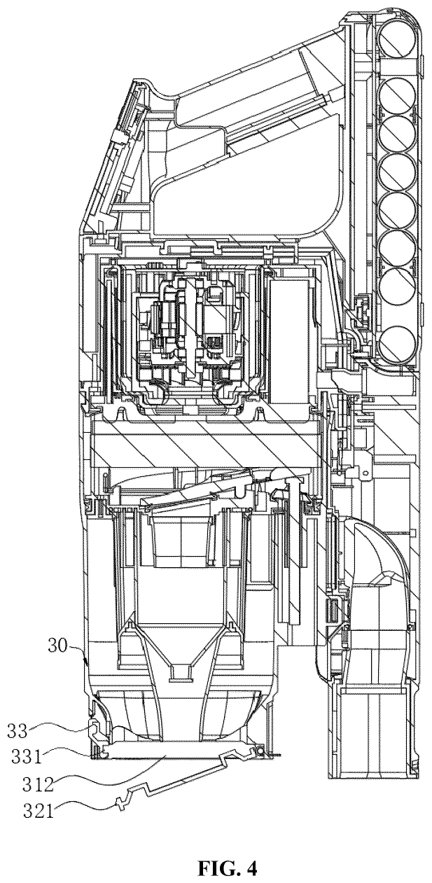

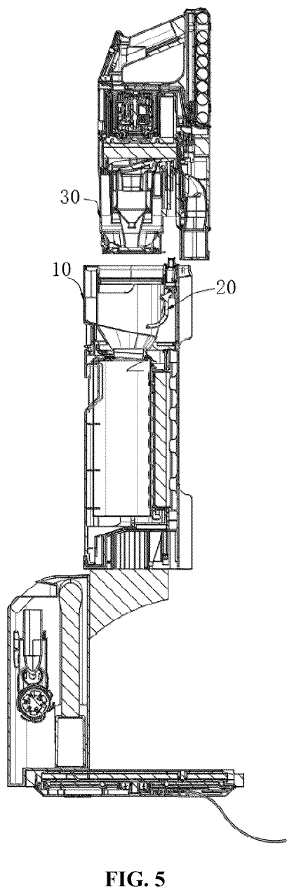

Referring to FIG. 1 to 5, the vacuum cleaner dust collection station 100 includes a main body 10 and a dust cup assembly 30. The main body 10 has a dust collecting chamber 11 inside. The top of the main body 10 is provided with an opening 12, which in communication with the dust collecting chamber 11. The dust cup assembly 30 can be accommodated in the dust collecting chamber 11 through the opening 12, or taken out of the dust collecting chamber 11 through the opening 12. The dust cup assembly 30 includes a cup body 31 and a bottom cover 32. The bottom of the cup body 31 is provided with a dust outlet 312. The bottom cover 32 is located at the dust outlet 312 and is rotatably connected to the cup body 31 for closing or opening the dust outlet 312. The driving assembly 20 is installed in the dust collecting chamber 11 and is configured to drive the bottom cover 32 to rotate and further close the dust outlet 312 as the dust cup assembly 30 is taken out of the dust collecting chamber 11.

In this way, the dust collecting chamber 11 inside the main body 10 is used to contain dust, and the opening 12 of the dust collecting chamber 11 can be used to put in and take out the vacuum cleaner. When the vacuum cleaner is used and then placed inside the main body 10, the dust cup assembly 30 is also placed in the dust collecting chamber 11. At this time, the bottom cover 32 of the dust cup assembly 30 is opened, and the dust accumulated in the dust cup assembly 30 can be poured into the dust collecting chamber 11 through the dust outlet 312 to achieve dust cleaning. The driving assembly 20 is configured to respond to the movement of the dust cup assembly 30. When the dust cup assembly 30 is taken out of the dust collecting chamber 11 in an upward direction, the driving assembly 20 can respond to the action, drive the bottom cover 32 to rotate and further close the dust outlet 312, so that the user does not need to frequently operate to close the dust outlet 312, and when the dust cup assembly 30 is taken out of the dust collecting chamber 11, the dust outlet 312 is already closed, so dust may not overflow outside the dust collecting chamber 11.

The driving assembly 20 has a variety of ways to drive the bottom cover 32 to rotate and further close the dust outlet 312. An electric control method can be adopted, such as setting a motor and a trigger member, the trigger member may be a pressure sensor or a photoelectric sensor, which is used to detect the movement of the dust cup assembly 30. When the dust cup assembly 30 moves and triggers the trigger member, the trigger member drives the motor, and the motor operates and drives other driving structures to close the bottom cover 32.

In the present application, the driving assembly 20 drives the bottom cover 32 to rotate by the movement of the dust cup assembly 30 itself, so the structure is simplified, and the cost and the failure rate are reduced. Two embodiments are taken as examples to explain in detail.

### First Embodiment

Referring to FIGS. 1 to 2 and 4, the driving assembly 20 includes a toggle rod 21, one end of which is rotatably connected to the inner wall of the main body 10, and the other end of which extends away from the inner wall of the main body 10. The toggle rod 21 can rotate around the end connected to the main body 10 and push the bottom cover 32 to rotate to close the dust outlet 312. In this way, the toggle rod 21 is a rod-shaped structure, which has a simple structure and a low processing cost. In addition, the rod-shaped structure is relatively slender, and it is not easy to interfere with other structures in the main body 10, and also convenient to realize a rotational connection with the inner wall of the main body 10.

The toggle rod 21 is arc-shaped and bends toward the axis of the main body 10. The arc-shaped toggle rod 21 has a higher structural strength and is not easy to break or damage when subjected to force. Moreover, since the toggle rod 21 bends toward the axis of the main body 10, only its end is in contact with the bottom cover 32, which reduces the contact area and avoids the wear caused by frequent contact between the toggle rod 21 and the bottom cover 32.

Of course, in other embodiments, the toggle rod 21 can also be in other shapes, such as a straight rod, or a multi-section bent rod structure composed of multiple straight rods, or an S-shaped or serpentine structure composed of multiple arcs, but is not limited to the above arcs.

When the dust cup assembly 30 leaves the dust collecting chamber 11, the end of the toggle rod 21 away from the inner wall of the main body 10 abuts against the center of the bottom cover 32, so that the bottom cover 32 is balanced, and the connection between the bottom cover 32 and the edge of the dust cup mouth is prevented from loosening due to frequent biased stress on the bottom cover 32.

Further, the toggle rod 21 is provided with a matching block 211, which is connected to the toggle rod 21 and extends away from the toggle rod 21. The edge of the dust outlet 312 is provided with a matching flange 322, which protrudes radially outward from the cup body 31. When the cup body 31 is placed in the dust collecting chamber 11, the matching block 211 overlaps the side of the matching flange 322 facing the opening 12. In this way, when the cup body 31 is taken out, the cup body 31 may move upward, that is, the matching flange 322 moves toward the side of the opening 12. Since the matching block 211 overlaps the side of the flange facing the opening 12, the matching block 211 can be driven by the matching flange 322 to move toward the direction of the opening 12. The mating block 211 is connected to the toggle rod 21, which naturally drives the toggle rod 21 to move. One end of the toggle rod 21 is connected to the inner wall of the main body 10, so the upward movement force is converted into a force rotating around the end, and the bottom cover 32 is abutted during the rotation. As the cup body 31 continues to move upward, the toggle rod 21 also continues to rotate until the bottom cover 32 is closed.

### Second Embodiment

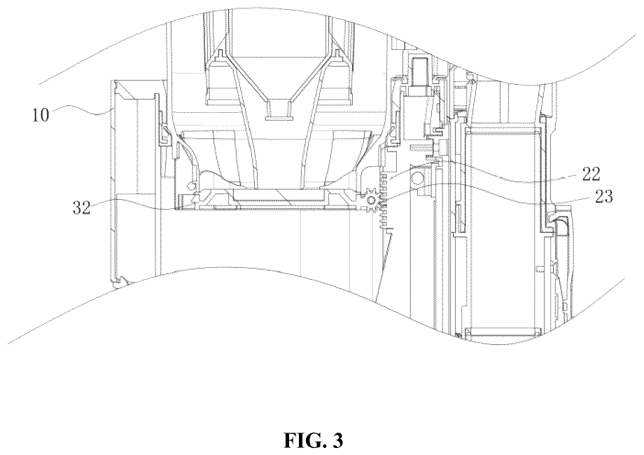

Referring to FIG. 3, the driving assembly 20 includes a rack 22, which is arranged on the inner wall of the main body 10 and arranged in the axial direction of the main body 10. The side of the bottom cover 32 facing the rack 22 is connected with a gear 23. The gear 23 can rotate in the moving direction of the dust cup assembly 30 and drive the bottom cover 32 to rotate synchronously. As the dust cup assembly 30 enters the dust collecting chamber 11 or is taken out of the dust collecting chamber 11, the gear 23 can mesh with the rack 22 and rotate. In this way, since the gear 23 is connected to the bottom cover 32, the rotation of the gear 23 may also drive the bottom cover 32 to rotate, thereby realizing the function of the bottom cover 32 opening the dust outlet 312 and closing the dust outlet 312. The position of the rack 22 corresponds to the gear 23, when the gear 23 follows the dust cup assembly 30 into the dust collecting chamber 11, the gear 23 is meshed with the rack 22, and the rack 22 is connected to the inner wall of the main body 10, so the rack 22 remains stationary. After the gear 23 is meshed with the rack 22, as the dust cup assembly 30 moves away from the opening 12 (that is, moves downward), the gear 23 rotates counterclockwise, thereby driving the bottom cover 32 to open, and the dust contained in the dust cup assembly 30 enters the dust collecting chamber 11 from the cup body 31 through the dust outlet 312. On the contrary, when the dust cup assembly 30 moves toward the cup mouth (that is, upwardly leaving the dust collecting chamber 11), the gear 23 rotates clockwise and drives the bottom cover 32 to close the dust outlet 312, thereby realizing the automatic closing of the bottom cover 32.

As the dust cup assembly 30 enters the dust collecting chamber 11 or is taken out of the dust collecting chamber 11, the gear 23 can rotate at least a quarter of a rotation. In this way, a quarter of a rotation of the gear 23 means that the bottom cover 32 can rotate 90 degrees, that is, the bottom cover 32 can be fully opened.

In order to optimize the closing effect of the above two embodiments on the bottom cover 32, the dust cup assembly 30 also includes a lock member 33, which is connected to the cup body 31. When the bottom cover 32 covers the dust outlet 312, the lock member 33 can prevent the bottom cover 32 from rotating. In this way, the lock member 33 ensures that the bottom cover 32 cannot be opened again after being closed, thereby preventing dust leakage.

Further, the lock member 33 is connected to the cup body 31, and the lock member 33 is provided with a slot 331, and protrusions 321 are provided on the outer peripheral wall of the bottom cover 32, and the protrusions 321 extend radially outwards, and can be snap fitted in the slot 331. In this way, the clamping structure of the protrusion 321 and the slot 331 is simple, easy to process, and has a stable connection.

Of course, it can be understood that in other embodiments, the lock member 33 can also be other structures, and is not limited to the above-mentioned slot 331. For example, the lock member 33 is set as a magnet, and a magnet of an opposite pole is set at the edge of the bottom cover 32 corresponding to the position of the lock member 33. When the bottom cover 32 approaches the lock member 33, the two magnets attract each other with opposite poles, so that the bottom cover 32 can be locked, and the above technical effect can also be achieved.

Furthermore, a mounting groove 311 is defined on the side wall of the cup body 31, and one notch, on one side, of the groove of the mounting groove 311 is defined on the outer peripheral wall of the cup body 31, and the other notch, on the other side, of the groove is defined on the inner peripheral wall of the cup body 31. The lock member 33 is installed in the mounting groove 311 and can rotate in the mounting groove 311. A slot 331 is defined at one end of the lock member 33 close to the dust outlet 312, and the other end of the lock member 33 extends toward the groove of the mounting groove 311 defined on the outer peripheral wall of the cup body 31. In this way, since the lock member 33 can rotate in the mounting groove 311, when the bottom cover 32 rotates and further closes, and the lock member 33 is rotated to the lock member 33 position, the end of the lock member 33 close to the bottom cover 32 can rotate in the radial outward direction of the cup body 31 to avoid the bottom cover 32. When the bottom cover 32 continues to rotate and finally completes the action of closing the dust outlet 312, and is stuck in the slot 331, the lock member 33 rotates in the radial inward direction of the cup body 31, that is, returns to the original position, thereby stably clamping the bottom cover 32. In addition, the outer peripheral wall of the cup body 31 is also provided with a notch of the mounting groove 311, so the user can press the end of the lock member 33 away from the dust outlet 312 through the notch to rotate it, thereby releasing the lock on the bottom cover 32 and allowing the bottom cover 32 to be opened.

The present invention also provides a cleaning system, including the dust collecting station 100 of the vacuum cleaner as described above.

Compared with the prior art, the present application contains dust through the dust collecting chamber 11 inside the main body 10, and the opening 12 of the dust collecting chamber 11 can be used for putting the vacuum cleaner in and taking the vacuum cleaner out. When the vacuum cleaner is used and then placed inside the main body 10, the dust cup assembly 30 is also placed in the dust collecting chamber 11. At this time, the bottom cover 32 of the dust cup assembly 30 is opened, and the dust accumulated in the dust cup assembly 30 can be poured into the dust collecting chamber 11 through the dust outlet 312, so as to achieve dust cleaning. The driving assembly 20 is configured to be able to respond to the movement of the dust cup assembly 30. When the dust cup assembly 30 is taken out of the dust collecting chamber 11 in an upward direction, the driving assembly 20 can respond to the action, drive the bottom cover 32 to rotate and close the dust outlet 312, so that the user does not need to frequently operate to close the dust outlet 312, and when the dust cup assembly 30 is taken out of the dust collecting chamber 11, the dust outlet 312 is already closed, so the dust may not overflow outside the dust collecting chamber 11.

The technical features of the above-mentioned embodiments can be combined arbitrarily. In order to make the description concise, all possible combinations of the technical features in the above-mentioned embodiments are not described. However, as long as there is no contradiction in the combination of these technical features, they should be considered to be within the scope of this specification.

The above-mentioned embodiments only express several implementation methods of the application, and the description is relatively specific and detailed, but it cannot be understood as a limitation on the scope of the application patent. It should be pointed out that, for ordinary technicians in this field, several modifications and improvements can be made without departing from the concept of the application, which are all within the scope of protection of the application. Therefore, the scope of protection of the application patent shall be based on the attached claims.

We claim:

1. A dust collecting station for a vacuum cleaner, comprising:
a main body, wherein the main body has a dust collecting chamber inside, and defining an opening at a top of the main body, the opening in communication with the dust collecting chamber;
a dust cup assembly, wherein the dust cup assembly is configured to be placed in the dust collecting chamber through the opening;
the dust cup assembly comprising a cup body and a bottom cover, a bottom of the cup body provided with a dust outlet, the bottom cover located at the dust outlet, rotatably connected to the cup body, for closing or opening the dust outlet; and
a driving assembly, wherein the driving assembly is installed in the dust collecting chamber, configured to drive the bottom cover to rotate and further close the dust outlet when the dust cup assembly is taken out of the dust collecting chamber.

2. The dust collecting station of claim 1 wherein the dust cup assembly further comprises a lock member, and the lock member is connected to the cup body to prevent the bottom cover that closes the dust outlet from rotating.

3. The dust collecting station of claim 2 wherein the lock member is connected to the cup body, the lock member is provided with a slot, a protrusion is provided on an outer peripheral wall of the bottom cover, and the protrusion extends outward along a radial direction of the bottom cover and is allowed to be snap fitted in the slot.

4. The dust collecting station of claim 3 wherein a mounting groove is defined on a side wall of the cup body, one notch of the mounting groove on one side is defined on an outer peripheral wall of the cup body, and the other notch of the mounting groove on an opposing side is defined on an inner peripheral wall of the cup body, the lock member is installed in the mounting groove and is rotatable in the mounting groove, the lock member is provided with the slot at one end close to the dust outlet, and wherein an opposing end of the lock member extends toward the notch of the mounting groove provided on the outer peripheral wall of the cup body.

5. The dust collecting station of claim 1 wherein the driving assembly comprises a toggle rod, one end of the toggle rod is rotatably connected to an inner wall of the main body, and another end of the toggle rod extends away from the inner wall of the main body, the toggle rod is rotatable around the end connected to the main body, and when the dust cup assembly leaves the dust collecting chamber, the end of the toggle rod away from the inner wall of the main body abuts against a center position of the bottom cover and drives the bottom cover to rotate, so as to close the dust outlet.

6. The dust collecting station according to claim 5 wherein a matching block (211) is provided on the toggle rod (21), the matching block (211) is connected to the toggle rod (21) and extends away from the toggle rod (21), and a matching flange (322) is provided on an edge of the dust outlet (312), and the matching flange (322) extends radially outwards; and
the matching block (211) overlaps a side of the matching flange (322) facing the opening (12) as long as the cup body (31) is placed in the dust collecting chamber (11).

7. The dust collecting station according to claim 5 wherein the toggle rod (21) is arc-shaped and bends toward an axis of the main body (10).

8. The dust collecting station of claim 1 wherein the driving assembly comprises a rack, the rack is arranged on the inner wall of the main body and arranged in an axial direction of the main body;
a gear is connected to a side of the bottom cover facing the rack, the gear being rotatable in a moving direction of the dust cup assembly and configured to drive the bottom cover to rotate synchronously;
wherein the gear is configured to be allowed to mesh with the rack and rotate when the dust cup assembly enters the dust collecting chamber or is taken out of the dust collecting chamber.

9. The dust collecting station of claim 8 wherein the gear is configured to be rotatable at least one quarter of a rotation when the dust cup assembly enters the dust collecting chamber or is taken out of the dust collecting chamber.
